(19) United States
(12) Patent Application Publication
(10) Pub. No.: US 2007/0124823 A1
(43) Pub. Date: May 31, 2007

(54) Video image reproducing apparatus and method of managing specified information of reproducing apparatus

(76) Inventor: Yoshitaka Tobita, Fuchu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,926

(22) Filed: Nov. 21, 2006

(30) Foreign Application Priority Data
Nov. 30, 2005 (JP) 2005-346092

(51) Int. Cl. G06F 17/30

(52) U.S. Cl. 726/32

(57) ABSTRACT

According to an embodiment of the invention, in an information reproducing apparatus and a method of managing specified information are disclosed. In reading and reproducing predetermined part of the information recorded in a recording medium, specified information permitting the reproduction of the information is generated, each time the apparatus is activated, using the identification information unique to a signal processing unit and a main control unit used for reproduction of the information including the number of the elements included in the signal processing unit and the main control unit. In this way, the illegal duplication and alteration of the content and the illegal reproduction thereof are prevented.

### CROSS-REFERENCE TO RELATED APPLICATIONS

This application is based upon and claims the benefit of priority from Japanese Patent Application No. 2005-346092, filed Nov. 30, 2005, the entire contents of which are incorporated herein by reference.

### BACKGROUND

1. Field

One embodiment of the invention relates to a reproducing apparatus for reproducing a video image and a method of managing specified information of the reproducing apparatus, and particularly to a method of recording and updating confidential information in a high-definition (HD) Digital Versatile Disk (DVD) video disk reproducing apparatus.

2. Description of the Related Art

With the advance of the digital compression encoding technique of dynamic images, a reproducing apparatus (player) capable of handling a high-resolution image of high-definition (HD) standard has already come to find practical applications.

In this player, an optical disk conforming to the High-Definition Digital Versatile Disk (HD DVD) standard is used as a storage medium. The use of the HD DVD makes it possible to store the video data of HD standard in an amount several times as large as the current DVD standard in a single disk together with the high-quality surround audio data.

On the other hand, the video data and audio data (digital signals) of HD standard, even after being duplicated, are barely degraded and therefore the illegal copying of content (hereinafter referred to simply as illegal copying) and the illegal alteration (hereinafter referred to simply as alteration) are required to be positively prevented at least from the viewpoint of copyright protection.

For this purpose, the reproducing apparatus is assigned “key information” (also referred to as “key code”) to prevent the illegal copying and the alteration, and in reproducing content, the authentication process using the key information is required. Also, in case of illegal copying or alteration of content, the prohibition of reproducing the particular content has been proposed.

For example, Japanese Patent Application Publication (KOKAI) No. 2005-148675 discloses a semiconductor device for authentication communication, comprising a communication control unit and an encryption processing unit formed on a single semiconductor chip on a CPU bus to make analysis of the CPU bus difficult and suppress the analysis of the technique of preventing the illegal copying.

In the method disclosed in this publication, however, the information flowing on the CPU bus is encrypted. Therefore, although this makes the analysis of the CPU bus difficult, a special mechanism is required for communication control. As a result, comparatively many workers are engaged in the jobs related to the LSI (or the circuit block) using the CPU bus, and therefore the information on the special mechanism for communication control is liable to leak unduly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information reproducing apparatus according to an embodiment of the invention;

FIG. 2 is an exemplary diagram showing an example of a structural feature of a main control block of the reproducing apparatus shown in FIG. 1 according to an embodiment of the invention;

FIG. 3 is an exemplary diagram showing an example of a structural feature of the main control block of the reproducing apparatus shown in FIG. 1 according to an embodiment of the invention;

FIG. 4 is a flowchart showing an example of the process of generating an encryption/decryption key for activating the reproducing apparatus shown in FIG. 1 according to an embodiment of the invention;

FIG. 5 is a flowchart showing an example of the process of generating a decryption key for reproducing the encrypted information of the reproducing apparatus shown in FIG. 1 according to an embodiment of the invention;

FIG. 6 is a flowchart showing an example of the process of generating an encryption/decryption key for the reproducing apparatus at the time of fabrication (factory shipment) of the reproducing apparatus according to an embodiment of the invention;

FIG. 7 is a flowchart showing an example of the process of reproducing the information recorded in a medium at the time of activating the reproducing apparatus according to an embodiment of the invention;

FIG. 8 is an exemplary diagram showing an example of a reproducing apparatus different from the information reproducing apparatus shown in FIG. 1 according to an embodiment of the invention;

FIG. 9 is a flowchart showing an example of the process of generating an encryption/decryption key at the time of activating the reproducing apparatus shown in FIG. 8 according to an embodiment of the invention;

FIG. 10 is a flowchart showing an example of the process of generating a decryption key for reproducing the encrypted information for the reproducing apparatus shown in FIG. 8 according to an embodiment of the invention;

FIG. 11 is a flowchart showing an example of the process of generating the encryption/decryption key for the reproducing apparatus shown in FIG. 8 at the time of fabrication thereof (at the time of factory shipment) according to an embodiment of the invention;

FIG. 12 is a flowchart showing an example of the process of reproducing the information recorded in a medium, at the time of activating the reproducing apparatus according to an embodiment of the invention;

FIG. 13 is a flowchart continued from the flowchart shown in FIG. 12 according to an embodiment of the invention;

FIG. 14 is an exemplary diagram showing an example of an information reproducing apparatus shown in FIG. 1 or FIG. 8 according to an embodiment of the invention; and

FIG. 15 is an exemplary diagram showing an example of a hardware configuration in an information reproducing apparatus shown in FIG. 1, 8 or 14.

### DETAILED DESCRIPTION

Various embodiments according to the invention will be described hereinafter with reference to the accompanying drawings. In general, according to one embodiment of the invention, in an information reproducing apparatus and a method of managing specified information are disclosed. In reading and reproducing predetermined part of the information recorded in a recording medium, specified information permitting the reproduction of the information is generated, each time the apparatus is activated, using the identification information unique to a signal processing unit and a main control unit used for reproduction of the information including the number of the elements included in the signal processing unit and the main control unit. In this way, the illegal duplication and alteration of the content and the illegal reproduction thereof are prevented.

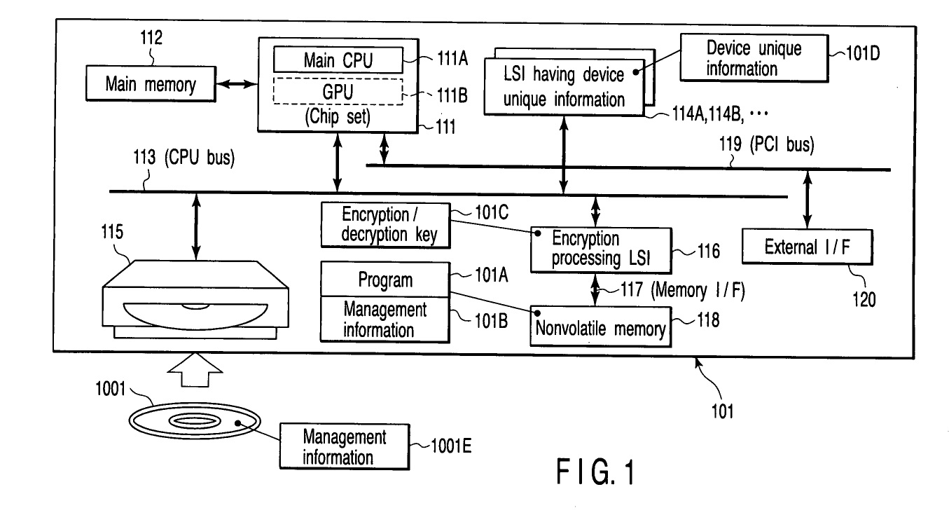

According to an embodiment of the invention, FIG. 1 is a diagram schematically showing an example of the configuration of an information recording and reproducing apparatus (optical disk apparatus) as a High-Definition Digital Versatile Disk (HD DVD) reproducing apparatus capable of reproducing information, i.e., content, from an optical disk (hereinafter referred to as a medium or media) of HD DVD standard.

The content stored in the optical disk of HD DVD standard is encrypted as video object units (VOBU) for copyright protection. The VOBU includes video data, audio data and navigation data. Also, an “identification code indicating the legitimacy” is prepared and stored in a predetermined area to identify the altered content and illegal duplication (hereinafter referred to as the illegal copy). To reproduce the content stored in a medium, therefore, a key (sometimes referred to as key information or key code) for decrypting the encrypted VOBU is of course required to be acquired and the legitimacy of the acquired key is required to be confirmed.

The HD DVD reproducing apparatus (player) 101 shown in FIG. 1 includes a main control block 111 making up a group of LSI/IC chips including a main CPU 111A, a main memory 112 connected to the main control block 111, a CPU bus 113 connected to the main control block 111, a plurality of signal processors (LSIs) 114A, 114B, . . . , are connected to the CPU bus 113 and a HD DVD drive unit 115 connected to the CPU bus 113. The main control block 111 may include a graphics processing unit (GPU) 111B in addition to the main CPU 111A. Also, a V-RAM (video memory) used as a work area to process the video signal explained later may be provided independently or occupy a part of the main memory 112.

Each LSI (signal processing unit) 114A, 114B, . . . , as described in detail later, typically is a video controller or audio controller having unique identification information (unique information) (each LSI is assigned the individual identification information).

The CPU bus 113 is also connected with an encryption processing LSI 116 including an encryption/decryption key (also called the key information or key code). Further, a nonvolatile memory 118 is connected to the encryption processing LSI 116 through a memory bus 117.

The HD DVD drive unit 115 reads the information such as the video data, the audio data and the navigation data recorded in the medium (i.e., the optical disk of HD DVD standard) described above, and though not shown, can retrieve the recorded information under the control of an integrated drive electronics (IDE) controller (not shown).

The encryption processing LSI 116 encrypts a program 101A and management information 101B recorded in the nonvolatile memory 118 on the one hand, and generates, in accordance with the flowchart described later with reference to FIG. 4, a decryption key 101C used for reproducing the video and audio information recorded in the medium (i.e., the HD DVD) on the other hand. The key 101C is generated by using information 101D unique to the internal devices of the player 101 typically including at least one serial number of signal processors (LSIs) 114A, 114B, . . . , are connected in an arbitrary number to the CPU bus 113 or the LAN physical address. The key 101C, therefore, is set arbitrarily for each player 101.

In the nonvolatile memory 118, the program (player application and the operating system [OS]) 101A for reproducing the video and audio information recorded in the HD DVD and the management information 101B are held in a state encrypted with the encryption/decryption key 101C held by the encryption processing LSI 116 (a state externally impossible to read easily).

The main control block 111 is also connected with external interfaces 120 connectable to permit connection of an arbitrary number of external devices such as personal computers through a peripheral component interconnect (PCI) bus 119 (which may alternatively be the CPU bus 113). The external interface 120 includes at least one of a Universal Serial Bus (USB), local area network (LAN) and Transmission Control Protocol/Internal Protocol (TCP/IP) which may be used by the user.

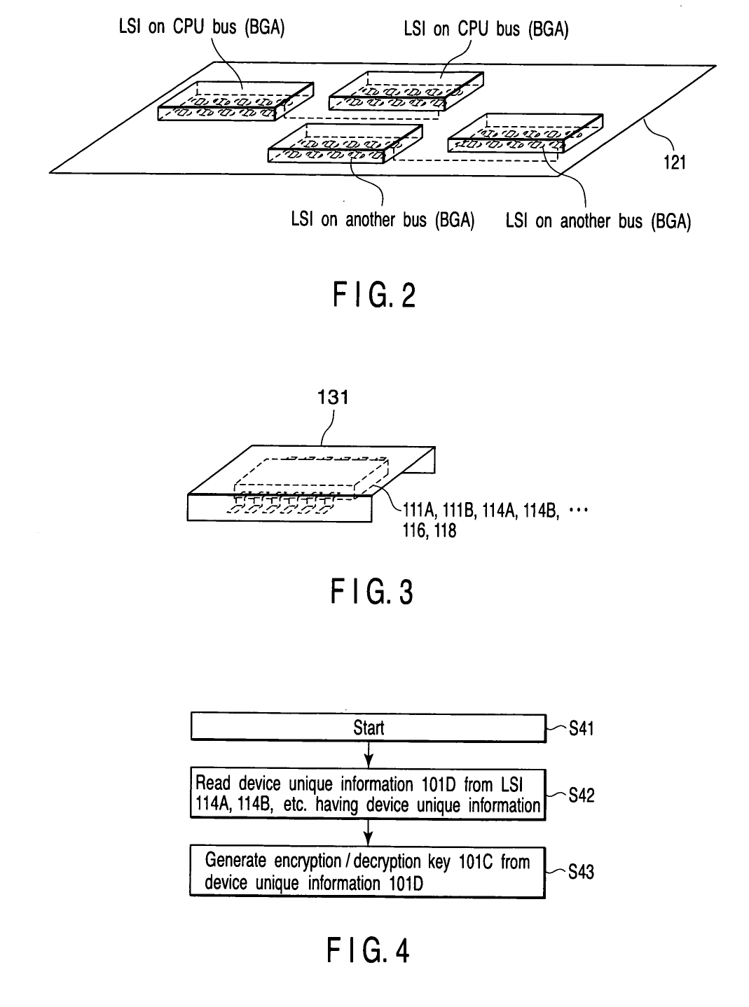

The CPU bus 113 preferably includes a substrate (121), with the terminal thereof not exposed, used for the main control block 111 of ball grid array (BGA) type as shown in FIG. 2. Also, two or more buses, not directly related to the LSI/IC such as the main CPU 111A, the signal processing units 114A, 114B, . . . , the encryption processing LSI 116 and the nonvolatile memory 118, are arranged in proximity to the CPU bus 113.

In this way, an arrangement (formation) more difficult to analyze is realized. As shown in FIG. 3, a cover 131 to prevent the connector, i.e., the terminal of the LSI/IC, from being exposed may be arranged on the LSI/IC connected with the CPU bus 113.

Next, the generation and management of the key in the player (reproducing apparatus) shown in FIG. 1 are explained. As described above, at the time of reproduction of a medium by the player 101, the key for decrypting the content encrypted and stored is acquired, and further the legitimacy of the acquired key is required to be confirmed (authenticated). At the same time, the requirement arises to prevent the key held in the player 101 from being illegally duplicated. For this reason, in the player 101 shown in FIG. 1, the key is desirably generated in the player 101 each time it is activated, while at the same time making it difficult to read the “key” from outside.

FIG. 4 shows the process of generating the encryption/decryption key at the time of activating the player shown in FIG. 1.

A medium to be reproduced is set, for example, in the HD DVD drive unit 115 or an activation command is given from an external device connected to the external interface 120. The activate operation, i.e., initialization (S41), is followed by the encryption processing LSI 116 reading the information 101D unique to the internal devices of the player 101 typically including the serial number unique to each of a plurality of signal processing units (LSIs) 114A, 114B, . . . , is connected to the CPU bus 13 and the physical address of LAN (S42).

Next, using an arbitrary number of information 101D read in step S42, the decryption key 101C used for reproducing the video and audio information recorded in the medium (i.e., the HD DVD) is generated (S43).

In this way, in the player 101 shown in FIG. 1, the key 101C difficult to read from outside is generated in the player each time the player is activated. Specifically, even in the case where the key 101C is illegally read, the generation of a new key 101C at the next activation session invalidates the illegally read key.

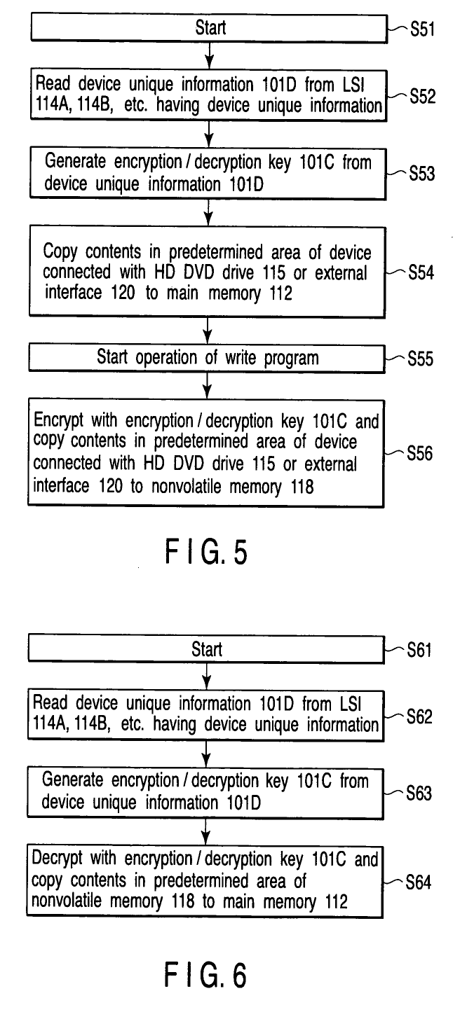

FIG. 5 shows the process of generating the decryption key for reproducing the program, i.e., the encrypted information, in the activated player.

By turning on a power switch (not shown), the player 101 is activated, and a predetermined activate operation, i.e., initialization (S51, equivalent to S41 in FIG. 4), is carried out.

Then, the encryption processing LSI 116 reads the information 101D unique to the internal devices of the player 101 typically including the serial number unique to each of a plurality of signal processing units (LSIs) 114A, 114B, . . . , are connected to the CPU bus 13 and the physical address of LAN (S52, equivalent to S42 in FIG. 4).

After that, the key 101C is generated by an arbitrary number of the information 101D read in step S52 (S53, equivalent to S43 in FIG. 4).

Next, the content of a predetermined area held in the HD DVD drive unit 115 or the external device, i.e., the program 101A and the management information 101B, is read and stored in the main memory 112 (S54). Then, a program is started to write the program 101A and the management information 101B stored in the main memory 112, into the nonvolatile memory 118 (S55). After that, the program 101A and the management information 101B stored in the main memory 112 in step S54 are encrypted and stored in the nonvolatile memory 118 (S56).

FIG. 6 shows the process of generating the encryption/decryption key at the time of player fabrication (factory shipment). Before generation of the key 101C at the time of activation, similar steps to those described above with reference to FIGS. 4 and 5 are executed, and therefore the corresponding steps, designated by the same “1” digit attached to each step, are not described in detail again.

After initialization (S61) at the time of activation of the player 101, the information 101D unique to the internal devices of the player 101 is read by the encryption processing LSI 116 and the key 101C is generated (S63).

Next, the required part of the content held in the nonvolatile memory 118 is decrypted with the encryption/decryption key 101C generated in step S63, and stored (copied) in a predetermined area of the main memory 112 (S64).

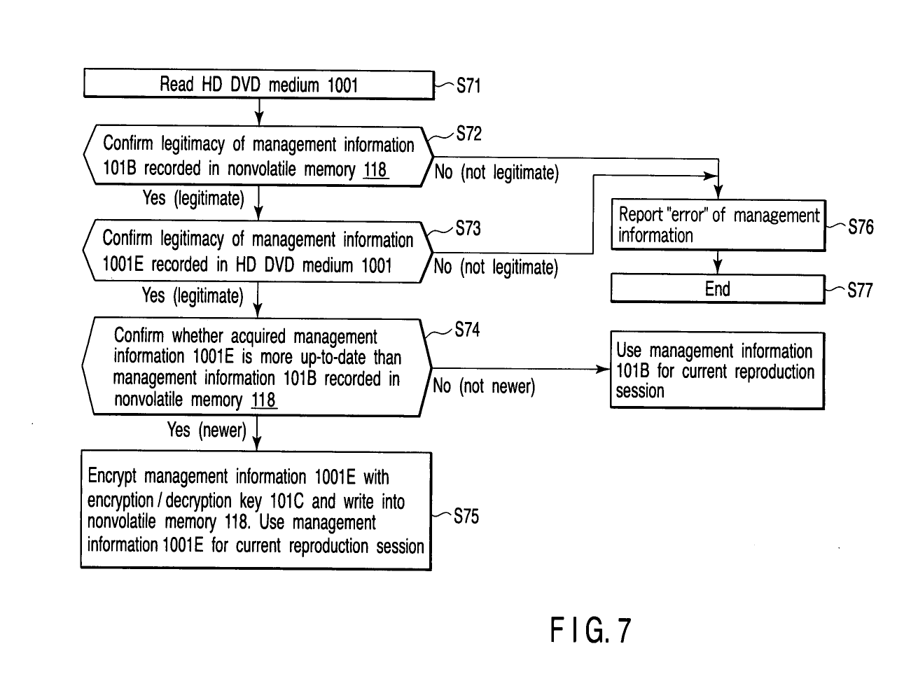

FIG. 7 shows an example of the process for reproducing the information recorded in the medium by the activated player. Each of the processes explained below with reference to FIG. 7 assumes a player which has been initialized based on the process shown in FIG. 6 and held in standby mode. Specifically, in accordance with the activation process shown in FIG. 6, the required part (information) of the content held in the nonvolatile memory 118 is decrypted with the encryption/decryption key 101C and stored in a predetermined area of the main memory 112, and in this state, a medium 1001 is set in the HD DVD drive unit 115.

In FIG. 7, upon confirmation that the medium (optical disk) 1001 is set in the disk drive unit 115 (S71), the legitimacy of the management information 101B included in the content (information) held in the nonvolatile memory 118 and copied to the main memory 112 is confirmed (S72).

Upon confirmation in step S72 that the management information 101B is legitimate (YES in S72), the legitimacy of (medium-side) management information 1001E stored in the predetermined area of the medium 1001 is confirmed (S73).

Upon confirmation in step S73 that the medium-side management information 1001E is legitimate (YES in S73), the acquired management information 1001E and the management information 101B held in the player are compared with each other thereby to determine whether the acquired management information 1001E is more up-to-date than the management information 101B by accessing, for example, the recorded date information, version information and update history (S74).

Upon determination in step S74 that the acquired management information 1001E is more up-to-date than the management information 101B (YES in S74), the acquired management information 1001E is encrypted with the encryption/decryption key 101C and overwritten on the management information 101B held in the nonvolatile memory 118. In the case where the acquired management information 1001E is contemporary with or older than the management information 101B (NO in S74), on the other hand, the management information 101B is accessed.

Then, the acquired management information 1001E (or the management information 101B) is accessed, so that the information including the video, music and text information stored in the medium 1001 is sequentially reproduced in accordance with the reproduction program (S75; the reproduction menu screen may of course be displayed depending on the player setting).

In the case where step S72 fails to confirm the legitimacy of the management information 101B (NO in S72), on the other hand, the service code or the message indicating, for example, “management information error” is displayed on the display, not shown, of the player 101 or the display unit connected thereto (S76). Also, the subsequent process is canceled (S77).

In the case where step S73 fails to confirm the legitimacy of the (medium-side) management information 1001E (NO in S73), on the other hand, the service code or the message indicating, for example, “management information error” is displayed on the display, not shown, of the player 101 or the display unit connected thereto (S76). Also, the subsequent process is canceled (S77).

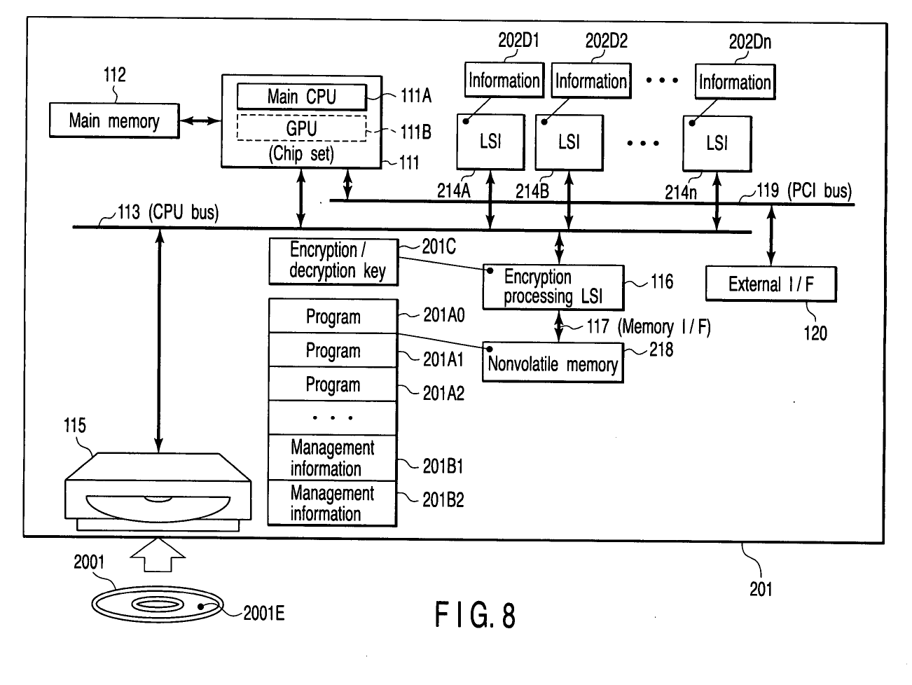

FIG. 8 shows the HD DVD reproducing apparatus described with reference to FIG. 1 according to another embodiment. The component parts (elements) identical with or similar to those shown in FIG. 1 are designated by the same reference numerals, respectively, and not described in detail.

As shown in FIG. 8, the HD DVD reproducing apparatus (player) 201 includes a main control block 111 constituting a group of LSI/IC chips having a main CPU 111A, a main memory 112 connected to the main control block 111, a CPU bus 113 connected to the main control block 111, a plurality of signal processing units (LSIs) 114A, 114B, . . . , are connected to the CPU bus 113 and a HD DVD drive unit 115 connected to the CPU bus 113. The main control block 111 may include a graphics processing unit (GPU) 111B in addition to the main CPU 111A. Also, in the main memory 112, a V-RAM (video memory) used as a work area for processing the video signal described later may be provided independently or occupy a part of the main memory 112.

Individual LSIs (signal processing units) 214A, 214B, . . . , 214n (n: arbitrary number), as described in detail later, typically each include the video controller or audio controller having unique identification information (unique information) (each LSI or IC is assigned the individual identification information). The CPU bus 113 is also connected with an encryption processing LSI 116 including an encryption/decryption key (which may be referred to as key information or key code). Also, the nonvolatile memory 218 is connected to the encryption processing LSI 116 through the memory bus 117.

The nonvolatile memory 218 holds a program 2A0 for activation, programs 201A1, 201A2, . . . for reproduction and management information 201B1, 201B2, the content of which is encrypted with an encryption/decryption key 201C.

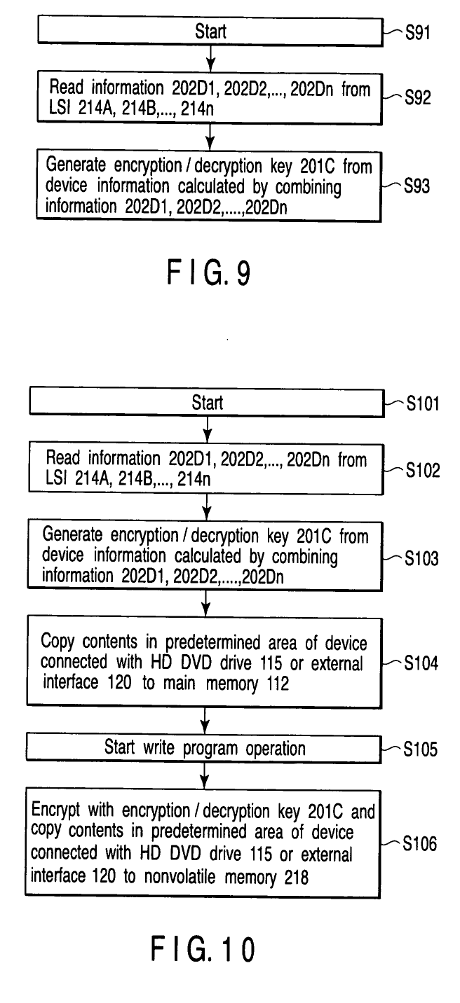

The encryption/decryption key 201C acquires, by the process of the encryption processing LSI 116 in accordance with the flowchart explained below with reference to FIG. 9, information 201C1, 201C2, . . . , 201Cn including the serial number unique to each device such as LSI or IC, the physical address of LAN and the device ID and the information such as the number of the devices (LSI/IC) from one or a plurality or an arbitrary number of LSI/ICs 214A, 214B, . . . , 214n, and combines the acquired information for calculation.

Specifically, in the HD DVD reproducing apparatus (player) 201, as shown in FIG. 9, a medium to be reproduced is set in the disk drive unit 115 or an activation command is issued from an external device connected to an external interface 120, so that the apparatus 201 is activated, i.e., initialized (S91), after which the encryption processing LSI 116 reads the information 201D1, 201D2, . . . , 201Dn unique to the internal devices of the player 201 typically including the serial number unique to each of the plurality of the signal processing units (LSIs) 214A, 214B, . . . , 214n connected to the CPU bus 113 and the physical address of LAN (S92).

Next, using the arbitrary number of the information 201D1, 201D2, . . . , 201Dn read in step S92, the decryption key 201C used for reproducing the video and audio information recorded in the medium (i.e., the HD DVD) is generated (S93).

In this way, the key 201C difficult to read from outside is generated in the player 201 shown in FIG. 8 each time the player is activated. Specifically, even in the case where the key 201C is read illegally, a new key 201C is generated at the time of next activation of the player 201, and therefore, the illegally read key is invalidated.

FIG. 10 shows the process of generating a decryption key for reproducing the program, i.e., the encrypted information, in the activated player.

Upon turning on of the power switch (not shown), the player 201 is activated and, following the predetermined activate operation, i.e., initialization (S101, equivalent to S91 in FIG. 9), the encryption processing LSI 116 reads the information 201D1, 201D2, . . . , 201Dn unique to the internal devices of the player 201 typically including the serial number unique to each of the plurality of the signal processing units (LSIs) 214A, 214B, . . . , 214n connected to the CPU bus 113 and the physical address of LAN (S102, equivalent to S92 in FIG. 9).

Next, the key 201C is generated by the arbitrary number of information 201D1, 201D2, . . . , 201Dn read in step S102 (S103, equivalent to S93 in FIG. 9).

Then, the content of a predetermined area held by the HD DVD drive unit 115 or the external unit, i.e., the programs 201A0, 201A1, 201A2, . . . and the management information 201B1, 201B2, is read and stored in the memory 112 (S104).

Then, the program is started for writing, into a nonvolatile memory 218, the programs 201A0, 201A1, 201A2, . . . , and the management information 201B1, 201B2 stored in the main memory 112 (S105). After that, in step S104, the programs 201A0, 201A1, 201A2, . . . , and the management information 201B1, 201B2 stored in the main memory 112 are encrypted and stored in the nonvolatile memory 218 (S106).

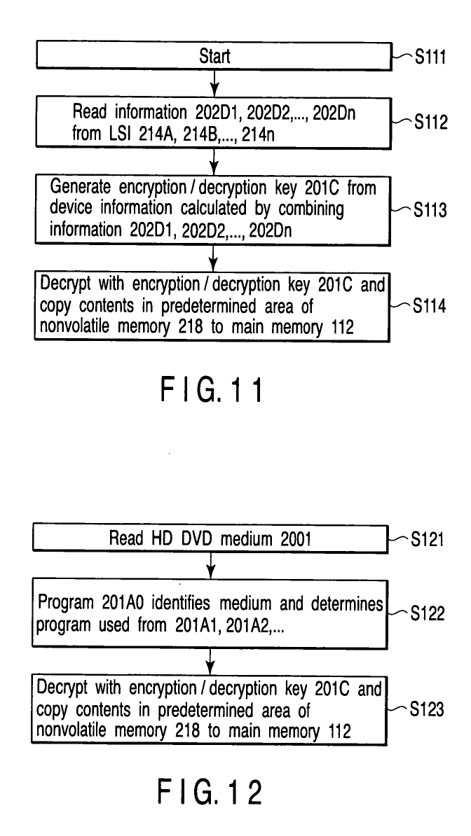

FIG. 11 shows the process of generating the encryption/decryption key at the time of player fabrication (shipment from factory).

At the time of fabrication, the HD DVD reproducing apparatus 201, in accordance with the flowchart of FIG. 10, is activated by the HD DVD drive 115 or the external interface 120 (S111). In the process, the encryption processing LSI 116 reads the information 201D1, 201D2, . . . , 201Dn unique to the internal devices of the player 201 typically including the serial number unique to each of the plurality of the signal processing units (LSI/ICs) 214A, 214B, . . . , 214n connected to the CPU bus 113 and the physical address of LAN (S112, equivalent to S92 in FIG. 9).

Next, using the arbitrary number of the information 201D1, 201D2, . . . , 201Dn read in step S102, the key 201C is generated (S113, equivalent to S93 in FIG. 9).

Then, the required part of the content held in the nonvolatile memory 218 is decrypted with the encryption/decryption key 201C generated in step S113, and stored (copied) in a predetermined area of the main memory 112 (S114).

FIG. 12 shows an example of the process for reproducing the information recorded in the medium with the player activated.

As already explained, in the player 201 initialized according to the process shown in FIG. 11 and in standby mode, a medium 2001 is set in the disk drive unit 115 and the type of the medium 2001 is read in accordance with the program 201A0 (S121).

Next, in accordance with the medium type thus read, an arbitrary one of the reproduction programs 201A1, 201A2, . . . , is selected (S122).

Next, the predetermined content stored in the nonvolatile memory 218 is decrypted with the encryption/decryption key 201C and copied to the main memory 112 (S123).

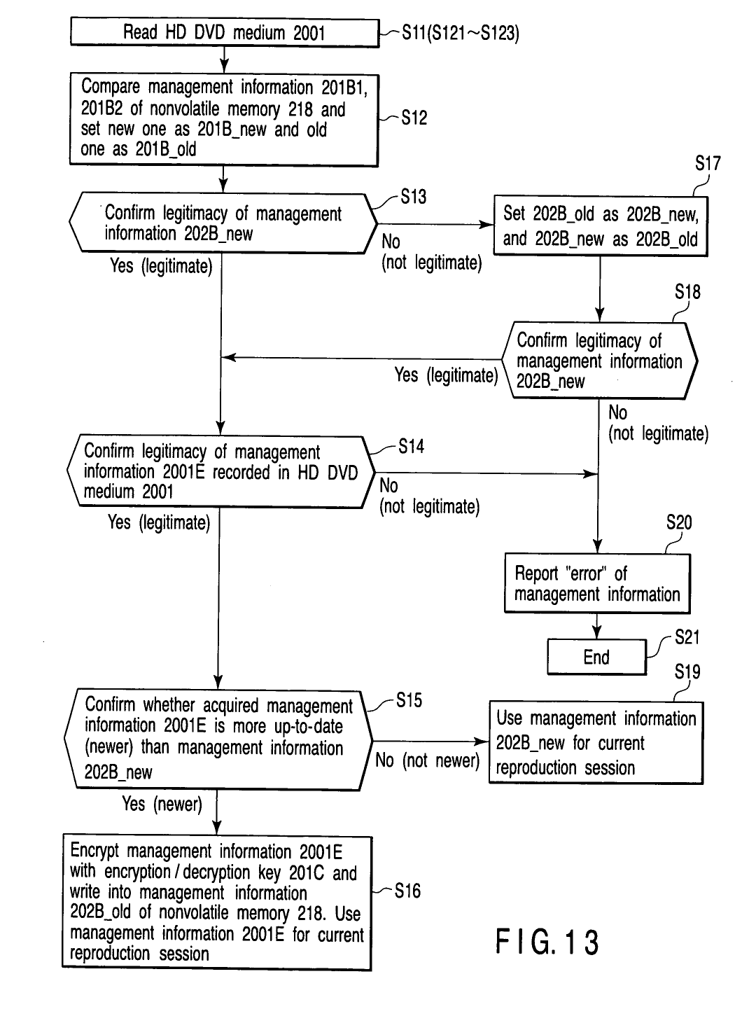

Then, in accordance with the flowchart shown in FIG. 13 (step S11 is equivalent to steps 121 to S123 shown in FIG. 12), the management information used for reproduction is determined, and the management information 201B1 or 201B2 is updated or initialized. The management information 201B1 and 201B2 are not updated both at a time. Even in the case where the power is switched off during the update process, therefore, one of the management information 201B1 and 201B2 manages to remain alive. Also, updated one of the two management information 201B1, 201B2 is assigned 201B_new and the remaining one (the old management information not updated) is assigned 201B_old, and used to determine the legitimacy of the management information described below (S12).

First, the legitimacy of the management information 201B_new updated in step S12 is confirmed (S13).

In the case where the legitimacy of the updated management information 201B_new is confirmed in step S13 (YES in S13), the legitimacy of (medium-side) management information 2001E stored in a predetermined area of the medium 2001 is confirmed (S14).

Once the legitimacy of the medium-side management information 2001E is confirmed in step S14 (YES in S14), the acquired management information 2001E and the (updated) management information 201B_new held in the player are compared with each other thereby to determine whether the acquired management information 2001E is more up-to-date than the management information 201B_new, by referring to, for example, the date information, version information and/or the update history recorded (S15).

In the case where step S15 determines that the acquired management information 2001E is more up-to-date than the management information 201B_new (YES in S15), the acquired management information 2001E is encrypted with the encryption/decryption key 201C, and overwritten on the management information 201B_old held in the nonvolatile memory 218. After that, the information such as video, music and text information stored in the medium 2001 are sequentially reproduced (in accordance with the reproduction program) with reference to the acquired management information 2001E (S16). In the case where the legitimacy of the updated management information 201B_new cannot be confirmed in step S13 (NO in S13), on the other hand, the updated management information 201B_new is replaced by the management information 201B_old not updated (S17), and the legitimacy of the resultant management information 201B_new (not updated) is confirmed (S18).

In the case where the legitimacy of the replacement management information (not updated) 201B_new is confirmed in step S18 (YES in S18), on the other hand, the content held (recorded) in the medium 2001 is reproduced by the process including and subsequent to step S14 described above.

In the case where the legitimacy of the management information 201B_new (not updated) cannot be confirmed in step S18 (NO in S18), on the other hand, the service code or the message indicating, for example, “management information error” is displayed on the display, not shown, of the player 201 or the display unit connected to an external device (S20), and the subsequent process is canceled (S21).

In the case where the legitimacy of the (medium-side) management information 2001E cannot be confirmed in step S14 (NO in S14), the service code or the message indicating, for example, “management information error” is displayed on the display, not shown, of the player 201 or the display unit connected to an external device (S20). At the same time, the subsequent process is canceled (S21).

In the case where step S15 determines that the acquired management information 2001E is not more up-to-date than (older than or contemporary with) the management information 201B_new (NO in S15), the management information 201B_new is determined as the one to be used for reproducing the information recorded in the medium 2001 (S19).

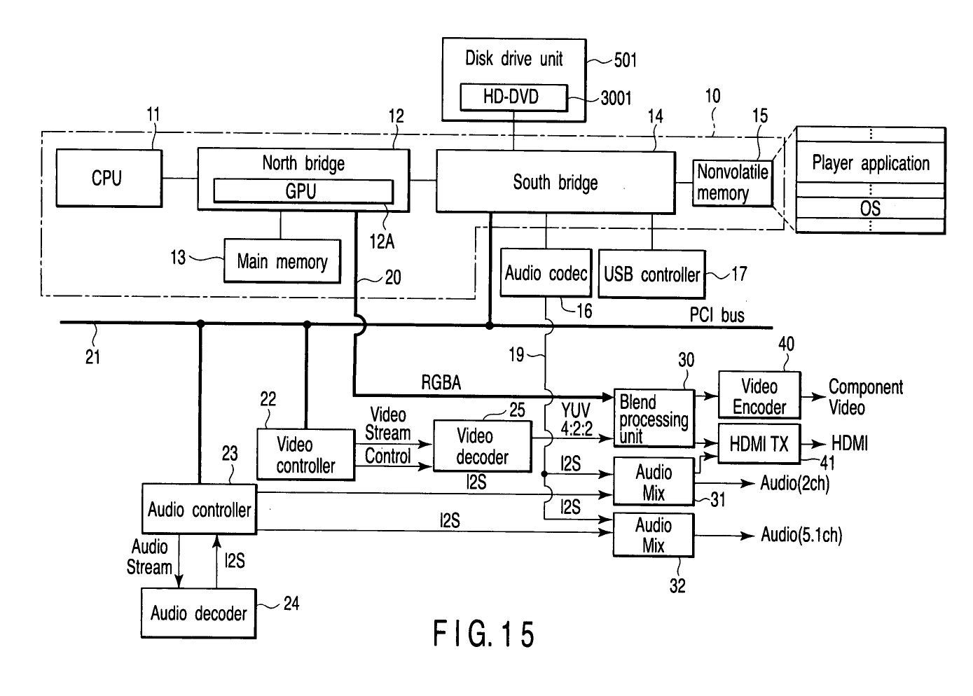

The foregoing explanation with reference to FIGS. 1, 8 and 14 mainly concerns the fact that the encryption/decryption of the content of the nonvolatile memory is controlled with the encryption processing LSI (the encryption/decryption is separated from the main CPU and shared by the encryption processing LSI). A specific hardware configuration for reproduction of the information stored in the medium by the player, however, can be implemented by the example explained below with reference to FIG. 15.

A reproducing apparatus 1 includes a main control block 10 including a CPU 11, a north bridge 12, a main memory 13, a south bridge 14 and a nonvolatile memory 15, an audio codec 16, a universal serial bus (USB) controller 17, a HD DVD drive 1, an audio bus 19, a graphics bus 20, a peripheral component interconnect (PCI) bus 21, a video controller 22, an audio controller 23, an audio decoder 24, a video decoder 25, a blend processing unit 30, audio mixers 31, 32, a video encoder 40 and an AV interface (HDMI-TX) 41 such as a high-definition multimedia interface (HDMI).

The key for controlling the operation of the player 1 is generated by the CPU 11 each time the player 1 is activated by an application between the main control block 10 and the nonvolatile memory 15.

A GPU 12A forms a graphics screen image from the data written by the CPU 11 in the video memory (VRAM) assigned to a part of the storage area of the main memory 13. The GPU 12A generates graphics data using the graphics operating function such as the bit block transfer. In the case where the image data (subvideo, subpicture, etc.) are written in the three planes on the VRAM by the CPU 11, for example, the GPU 12A executes, by bit block transfer, the blending process for superposing the image data associated with the three planes one on another for each pixel, thereby generating the graphics data for forming the graphics screen image having the same resolution (say, 1920×1080 pixels) as the main video.

The HD DVD drive 1 is for driving the accumulated media such as the HD DVD media having stored therein the audio-video (AV) content corresponding to the HD DVD standard.

The audio codec 16 converts the subaudio data decoded by software into the digital audio signal of I2S (inter-IC sound) format. The audio codec 16 is connected to the audio mixers 31, 32 through the audio bus 19. The audio bus 19 is a transmission line connected between the audio codec 16 and the audio mixers 31, 32. Through this audio bus 19, the digital audio signal from the audio codec 16 is transmitted to the audio mixers 31, 32 without the intermediary of the PCI bus 21.

The video controller 22 is connected to the PCI bus 21. This video controller 22 is a LSI to implement the interface with the video decoder 25. The stream of the main video data (video stream) separated from the HD DVD stream by software is sent to the video decoder 25 through the PCI bus 21 and the video controller 22. Also, the decode control information output from the CPU 11 is sent to the video decoder 25 through the PCI bus 21 and the video controller 22.

The video decoder 25 decodes the main video data and generates the digital YUV video signal to form a video screen image having the resolution of 1920×1080 pixels. This digital YUV video signal is sent to the blend processing unit 30.

The audio controller 23 is connected to the PCI bus 21. The audio controller 23 is a LSI for implementing the interface with the audio decoder 24. The main audio stream separated from the HD DVD stream by software is sent to the audio decoder 24 through the PCI bus 21 and the audio controller 23.

The audio decoder 24 generates the digital audio signal of I2S (inter-IC sound) format by decoding the main audio data. This digital audio signal is sent to the audio mixers 31, 32 through the audio controller 23.

The blend processing unit 30, coupled with the GPU 12A and the video decoder 25, executes the blending process in which the graphics data output from the GPU 12A is superposed on the main video data decoded by the video decoder 25. In this blending process (alpha blending process), the digital RGB video signal making up the graphics data and the digital YUV video signal making up the main video data are superposed one on the other by pixel based on the alpha data output together with the graphics data (RGB) from the GPU 12A. In the process, the main video data is used as a lower screen image, while the graphics data is used as an upper screen image superposed on the main video data.

The output image data obtained by the blending process is supplied to the video encoder 40 and the AV interface (HDMI-TX) 41 as a digital YUV video signal, for example. In the video encoder 40, the output image data (digital YUV video signal) obtained by the blending process is converted into a component video signal or a S-video signal, and output to an external display unit (monitor) such as a TV receiver. The AV interface (HDMI-TX) 41 outputs the digital signals including the digital YUV video signal and the digital audio signal to the external HDMI device.

In the audio mixer 31, the subaudio data decoded by the audio codec 16 and the main audio data decoded by the audio decoder 24 are combined (mixed) with each other, and the mixing result is output as a stereo audio signal.

In the audio mixer 32, on the other hand, the subaudio data decoded by the audio codec 16 and the main audio data decoded by the audio decoder 24 are combined (mixed) with each other, and the mixing result is output as an audio signal of 5.1 channel.

A medium (optical disk) 3001 having stored therein the audio-video (AV) content of HD DVD standard is set in an HD DVD drive 501 connected to the player 1 having the aforementioned hardware configuration. Thus, a player is obtained in which the content illegally copied or altered as described above with reference to FIGS. 4 to 7 or 9 to 13 cannot be reproduced and in which the key and the authentication process are difficult to analyze.

As explained above, according to this invention, the encryption/decryption of the content of the nonvolatile memory are controlled by the encryption processing LSI (the encryption/decryption process is separated from the main CPU and shared by the encryption processing LSI), so that the program operating in the main CPU (main control block) can be set without regard to the encryption of the content of the nonvolatile memory. As a result, all the members engaged in the development are not required to access the confidential information, and the likelihood of the secrets to leak out to third parties from the development members is reduced.

Also, the content of the nonvolatile memory is encrypted/decrypted in such a manner that at the time of player fabrication, the encryption processing LSI generates the encryption key using the device ID and the serial number of the LSI on the CPU bus or the device information such as the number of units, and the reproduction program and the management information are encrypted and recorded in the nonvolatile memory. The encryption key required for device operation, therefore, depends on the device information for fabrication.

Even in the case where the parts used are changed for the reason of fabrication, therefore, an encryption key can be generated normally and the reproduction program and the management information can be encrypted and recorded in the nonvolatile memory without any change of the encryption processing LSI, etc. Even in that case, the reproducing apparatus can generate a correct encryption key after shipment.

As a result, in the case where an attacker connects an analysis device to the CPU bus, for example, the apparatus cannot generate a correct encryption key and fails to operate normally. In this way, the illegal copying of the key and the analysis of the mechanism (reproducing apparatus) for authentication and key generation are very difficult.

In view of the fact that the encryption processing LSI generates an encryption key within the LSI using the device information such as the device ID and the number of the LSIs on the CPU bus, the key (encryption key) in its complete form is not passed through the CPU bus, etc.

Thus, it is very difficult to copy the key illegally or analyze the mechanism (reproducing apparatus) for authentication or key generation by illegal access from outside.

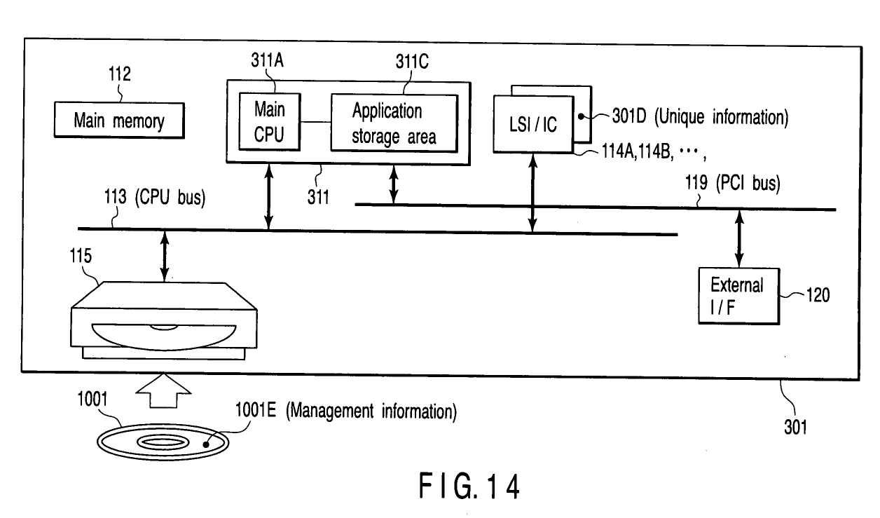

Also, the key (encryption key) for the player (reproducing apparatus) described above with reference to FIGS. 1 and 8 can of course be generated, as explained below with reference to FIG. 14, as a firmware corresponding to an application (program) stored in an application (program) holding area (memory) 311C connected to a main CPU 311A of a main control block 311.

As described above, the HD DVD reproducing apparatus using a multipurpose processor described herein operates by reading the reproduction program and the management information into the main memory from the nonvolatile memory in the devices.

Also, the nonvolatile memory in the devices of the HD DVD reproducing apparatus has recorded therein the management information for reproduction. The HD DVD reproducing apparatus in reproducing operation checks whether the management information held by the medium is legitimate or not.

In the case where the particular management information is legitimate, it is compared with the management information recorded in the nonvolatile memory in the devices to determine which is more up-to-date, and the newer management information is used for reproduction. Also, the newer management information is recorded in the nonvolatile memory in the devices. As a result, the undesired analysis of the key information for the apparatus is suppressed.

Also, according to this invention, the encryption processing chip is connected to the CPU bus, while the nonvolatile memory is not. This invention is not applied to the CPU bus, and therefore the persons informed of the application of the invention to the devices can be limited. As a result, the leakage of the application of the invention to external entities is suppressed. Also, no special mechanism is required for the control operation.

Further, the reproducing apparatus according to this invention generates an encryption key using the information such as the ID and number of the LSIs connected to the CPU bus each time of activation. In the case where the apparatus is altered by an attacker and an analysis device is connected to the CPU bus, an incorrect encryption key is generated and the apparatus fails to operate normally. As a result, the analysis of the apparatus can be suppressed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
a read unit which reads a predetermined part of information from a recording medium holding the information;
a signal processing unit which reproduces the information read from the recording medium, in a form adapted to be displayed on a display unit;
a main control unit which controls the signal processing unit;
a key generating unit which generates key information for permitting the reproduction of the information read from the recording medium, by the signal processing unit; and
a key storage unit arranged in spaced relation with a signal line connected with the signal processing unit and the main control unit connected to the key generating unit through a dedicated interface and adapted to reproduce the information.

2. The information reproducing apparatus according to claim 1, wherein the key information is generated anew by the key generating unit each time the apparatus is activated.

3. The information reproducing apparatus according to claim 2, wherein the key information is generated anew by the key generating unit based on identification information unique to the signal processing unit and the main control unit including the number of the elements included in the signal processing unit and the main control unit.

4. The information reproducing apparatus according to claim 2, wherein the key information is generated at the time of fabrication of the apparatus based on the identification information unique to the signal processing unit and the main control unit including the number of the elements included in the signal processing unit and the main control unit.

5. An information reproducing apparatus comprising:
a read unit which reads a predetermined part of the information from a recording medium holding the information;
a signal processing unit which reproduces the information read from the recording medium, in a form adapted to be displayed on a display unit;
a key generating unit which generates key information for permitting the reproduction of the information read from the recording medium, by the signal processing unit;
a main control unit which controls the signal processing unit independently of the operation of the key generating unit; and
a key storage unit arranged in spaced relation with a signal line connected with the signal processing unit and the main control unit connected to the key generating unit through a dedicated interface and adapted to reproduce the information.

6. The information reproducing apparatus according to claim 5, wherein the key information is generated by the key generating unit without permitting variation in identification information unique to the signal processing unit and the main control unit including the number of the elements included in the signal processing unit and the main control unit.

7. A method of managing specified information of an information reproducing apparatus, comprising the steps of:
reading a predetermined part of information recorded in a recording medium; and
generating information permitting, each time the apparatus is activated, the reproduction of the predetermined part of the information using identification information unique to a signal processing unit and a main control unit including the number of the elements included in the signal processing unit and the main control unit used for reproduction of the information.

8. The method of managing specified information of an information reproducing apparatus according to claim 7, wherein the information permitting the reproduction of the information permits no variation of the identification information unique to the signal processing unit and the main control unit including the number of the elements of the signal processing unit and the main control unit used for reproduction of the information.
